(19) United States
(12) Patent Application Publication
(10) Pub. No.: US 2020/0133660 A1
(43) Pub. Date: Apr. 30, 2020

(54) TECHNOLOGY COMPATIBILITY DURING INTEGRATION OF AN IT SYSTEM

(71) Applicant: INTERNATIONAL BUSINESS MACHINES CORPORATION, Armonk, NY (US)

(72) Inventors: Sanjay D. Bhat, Flower Mound, TX (US); Radha Naarayanan, Yerawada (IN)

(21) Appl. No.: 16/175,809

(22) Filed: Oct. 30, 2018

(51) Int. Cl. G06F 8/71

(52) U.S. Cl. CPC G06F 8/71; G06F 8/656

(57) ABSTRACT

A method of integrating a computing system that includes: identifying component products for the computing system; identifying possible versions of each of the component products; prioritizing the possible versions for each of the component products so as to emphasize those versions that are most important to a user of the computing system; selecting one product as a primary product of the computing system with the remaining products being subsidiary products; forming a technology matrix of possible combinations of primary product, subsidiary products and possible versions of the subsidiary products; and selecting the combination of primary product, subsidiary product and subsidiary product version having the highest prioritization; wherein the method is implemented by a processor.

### BACKGROUND

The present exemplary embodiments pertain to technology compatibility between technology components and, more particularly, pertain to technology compatibility during integration of Information Technology (IT) components.

Migrations, upgrades and transformations (collectively referred to as “transformations”) are ways of keeping technologies up to date in an Enterprise's IT organization. All of these transformation impact not only the technology that is being upgraded, migrated or transformed but have a significant impact on technologies and applications that surround these technologies. It takes a great deal of effort and time to identify technical compatibilities when a large part of an IT Enterprise is to be transformed.

While a vast database of technologies exists today, with their complex inter-relationships there is no one way to identify relationships between changing technology components, their upgrades, security vulnerabilities, licensing, support life cycles etc. which will help business and IT departments decide on what, when and how to begin any technology build or refresh.

### BRIEF SUMMARY

The various advantages and purposes of the exemplary embodiments as described above and hereafter are achieved by providing, according to an aspect of the exemplary embodiments, a computer-implemented method of integrating a computing system comprising: identifying component products for the computing system; identifying possible versions of each of the component products; prioritizing the possible versions for each of the component products so as to emphasize those versions that are most important to a user of the computing system; selecting one product as a primary product of the computing system with the remaining products being subsidiary products; forming a technology matrix of possible combinations of primary product, subsidiary products and possible versions of the subsidiary products; selecting the combination of primary product, subsidiary product and subsidiary product version having the highest prioritization; wherein the method is implemented by a processor.

According to another aspect of the exemplary embodiments, there is provided a computer program product for integrating a computing system, the computer program product comprising: a computer readable storage medium having computer readable program code embodied therewith, the computer readable program code comprising: computer readable program code configured to identify component products for the computing system; computer readable program code configured to identify possible versions of each of the component products; computer readable program code configured to prioritize the possible versions for each of the component products so as to emphasize those versions that are most important to a user of the computing system; computer readable program code configured to select one product as a primary product of the computing system with the remaining products being subsidiary products; computer readable program code configured to form a technology matrix of possible combinations of primary product, subsidiary products and possible versions of the subsidiary products; and computer readable program code configured to select the combination of primary product, subsidiary product and subsidiary product version having the highest prioritization.

According to a further aspect of the exemplary embodiments, there is provided a system for integrating a computing system comprising: a processor that executes the instructions to perform the following functions: identify component products for the system; identify possible versions of each of the component products; prioritize the possible versions for each of the component products so as to emphasize those versions that are most important to a user of the system; select one product as a primary product of the system with the remaining products being subsidiary products; form a technology matrix of possible combinations of primary product, subsidiary products and possible versions of the subsidiary products; and select the combination of primary product, subsidiary product and subsidiary product version having the highest prioritization.

### BRIEF DESCRIPTION OF SEVERAL VIEWS OF THE DRAWINGS

The features of the exemplary embodiments believed to be novel and the elements characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is an illustration of an electronic device for implementing the exemplary embodiments.

FIG. 2 is an illustration of the exemplary embodiments.

FIG. 3 is an illustration of an integration of the technology products in system A to technology products in system B.

FIG. 4 is an illustration a relationship matrix which is a dynamic algorithm for hierarchical relationships.

FIG. 5 is an illustration is a table of a user's requirements for a system.

FIG. 6 is an illustration of a table listing level 1 product combinations by version where the primary product is a Weblogic server.

FIG. 7 is an illustration of a listing of various level 2 technology parameter combinations for the primary product, the Weblogic server.

FIG. 8 is an illustration of the product weightages from the FIG. 6 and FIG. 7 tables combined to result in a modified table of the FIG. 6 table.

FIG. 9 is an illustration of another table of a user's requirements for a system.

FIG. 10 is an illustration of a table summarizing the end result of the processes in FIGS. 5 to 9.

FIG. 11 is an illustration a companion table to the table in FIG. 10.

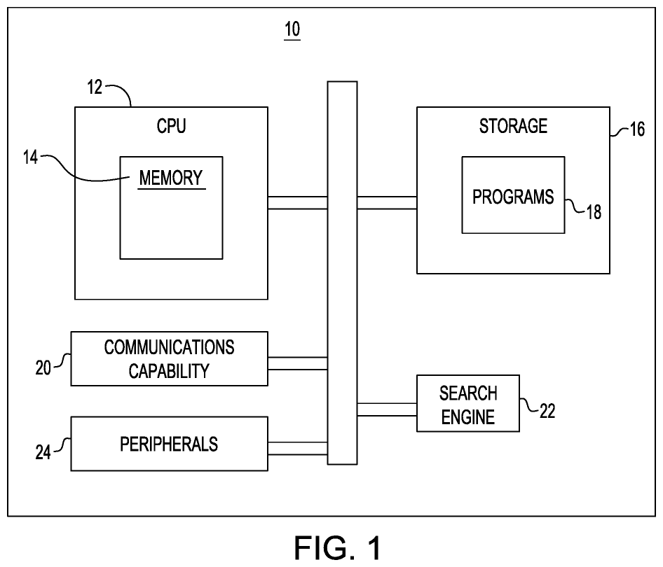

### DETAILED DESCRIPTION

There is a need for a way of looking at the mesh of vendor documents across technologies and derive relationships that can both provide guidance for inplace upgrades as well as a roadmap to the future.

The exemplary embodiments provide a vendor agnostic solution which may be used for any specific combination of technologies at any point in time, thereby reducing an enormous amount of time sifting through a maze of documents to identify relationships and compatibilities among technologies.

The exemplary embodiments may be applied or extended to any industry with multiple subcomponents which also has multiple vendors, components and subcomponents. For the purpose of illustration and not limitation, the exemplary embodiments may be applied to manufacturing, automotives, aerospace and retail or any industry whenever there are multiple vendors and products that need to work with each other.

The exemplary embodiments propose a comprehensive framework and model for providing a living persistent store to store technology details across vendor products and services in the IT space, and derive complex compatibility relationships amongst multiple inter-connected technologies.

Referring to the Figures in more detail, there is shown an electronic device 10 for implementing the exemplary embodiments. The electronic device 10 may include a central processing unit (CPU) 12 having memory 14.

Further contained within electronic device 10 may be storage 16. Alternatively, storage 16 may be remotely connected to electronic device 10. Contained within storage 16 may be programs 18 having program instructions to perform various tasks.

The electronic device 10 may further include communications capability instructions 20 to allow electronic device 10 to communicate with the outside world such as by WiFi, cellular, satellite, wired or short range radio capabilities. There may also be search engine instructions 22 to search the Internet and to provide browsing capability to the electronic device.

Additionally, electronic device 10 may have peripherals instructions 24 to operate peripheral components such as a display, keyboard, mouse and printer.

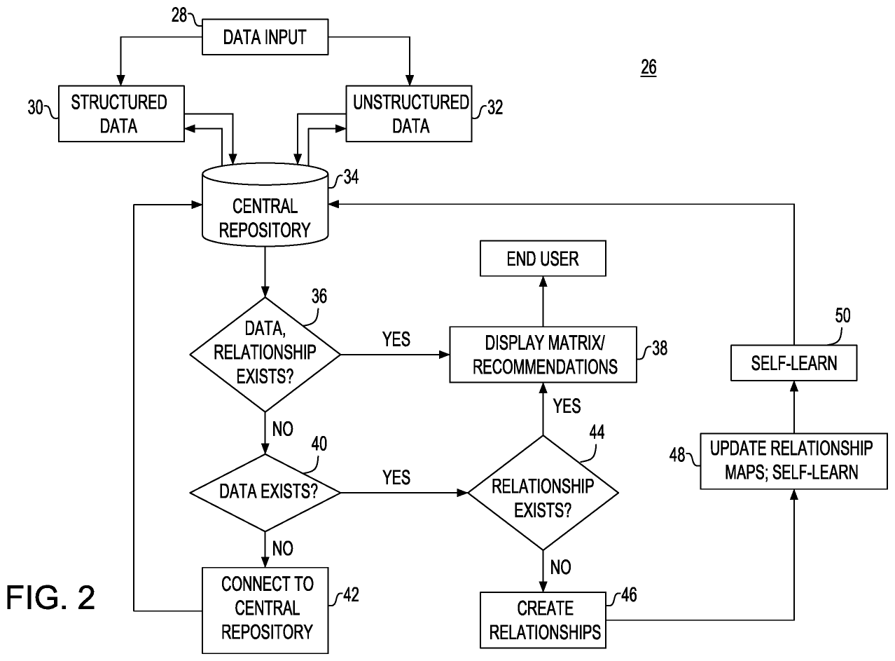

Referring now to FIG. 2, there is illustrated a method 26 of the exemplary embodiments.

For a variety of technology transformations, data 28 may be collected. The data 28 may be structured data 30 or unstructured data 32. Structured data 30 may be considered to be, for example, published documents/articles from vendors (such as references to test case, user experiences), published vendor technotes, technical information regarding a vendor's products, and other documents from a vendor's technical database. Unstructured data 32 may considered to be, for example, blogs, user forums, vendor-supported user forms and social media in general. The data 28 may be collected by a central repository 34 which may analyze the data 28 for its relevance to the technology transformations and weight the value of the data 28.

For a given technology transformation, it is determined 36 if data relevant to a particular technology transformation exists and also if relationships between technology products for the technology transformation exist. If the answer is “yes”, the method proceeds along the “yes” path to display a matrix table of technology relationships and make recommendations to the end user, 38.

If it is determined that both data and relationships for the technology transformation do not exist, then the “no” path is followed.

At 40, it is determined if data alone exists relevant to the particular technology transformation. If the answer is “no”, the “no” path is followed at 42 to connect to the central repository 34 to collect more data. If data does not exist in the central repository 34, the central repository 34 may reach out to the structured data 30 and unstructured data 32 to pull data into the central repository 34. The central repository 34 may reach out automatically when more data is to be collected or through a manual trigger.

If the answer is “yes”, the “yes” path is followed to determine again if relationships between technology products for the technology transformation exist, 44. If the answer here is “yes”, then the method proceeds along the “yes” path to display a matrix table of technology relationships and make recommendations to the end user, 38.

If the answer is “no”, that relationships between technology products for the technology transformation do not exist, then the “no” path is followed to create relationships for the technology transformation 46 and then to update the relationship maps, 48.

As relationships between technology products are updated, there is also a learning process which improves the weighting of each of the technology products, 50. Outputs of the learning process may be input to the central repository 34.

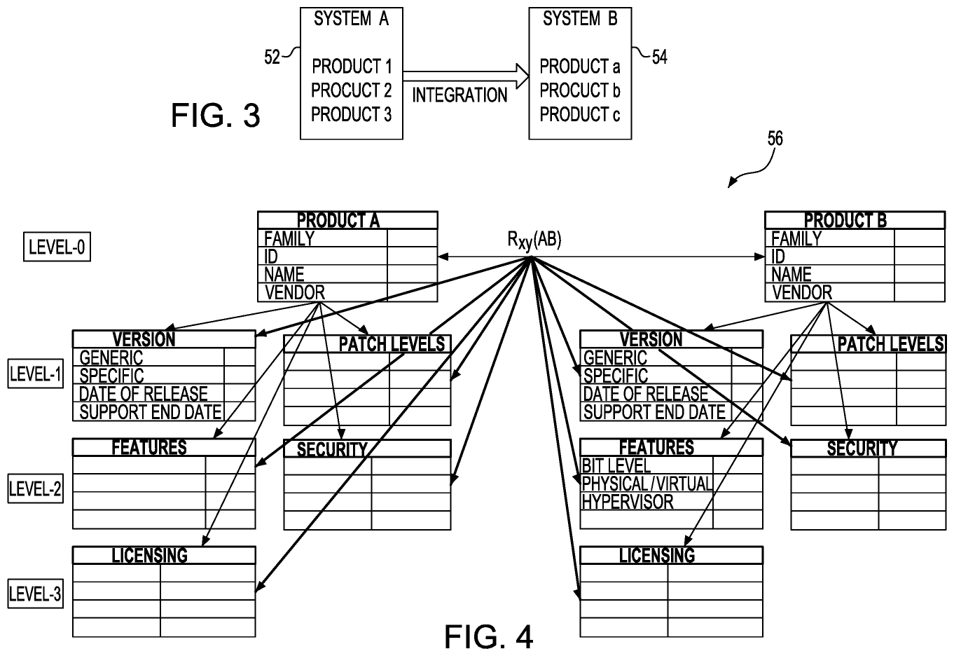

FIG. 3 illustrates an advantage of the exemplary embodiments. It is desired to integrate system A 52 having component products 1 to 3 to system B 54 having component products a to c. Component products and products may be used interchangeably herein. Some of the products 1 to 3 may be the same as products a to c and others may be different or just variations of products 1 to 3. For example, product 1 in system A 52 may be a database and product a in system B 54 may be the same database but an updated version. The process of FIG. 2 may be applied to facilitate the integration.

More particularly, FIG. 3 illustrates the integration between two systems where each of the systems are composed of multiple products. The integration of system A 52 to system B 54 may cause a certain set of requirements for transforming system A 52 to be integratable with system B 54. Further, the transformation of system A 52 may introduce constraints on system B 54 to transform system B 54 itself to still be integratable with system A 52.

FIG. 4 illustrates a relationship matrix 56 (a dynamic algorithm for hierarchical relationships). Multiple relationships can exist between any two given products such as Product A and Product B shown in FIG. 4. Different relationships may exist between these products based on the values for different parameters. Extending this concept, Product A may have multiple relationships with different products (other than Product B) based on parameters that define the products.

Relationships may be defined in decreasing order of hierarchy, with relevant weights at each level. For the purpose of limitation, FIG. 4 shows four levels of hierarchy, namely, level 0, level 1, level 2 and level 3. There may be additional levels not shown here.

Extending the concept to multiple products, complex relationships may be built between products based on the same concept. These relationships may be canned (static) or may be built at runtime.

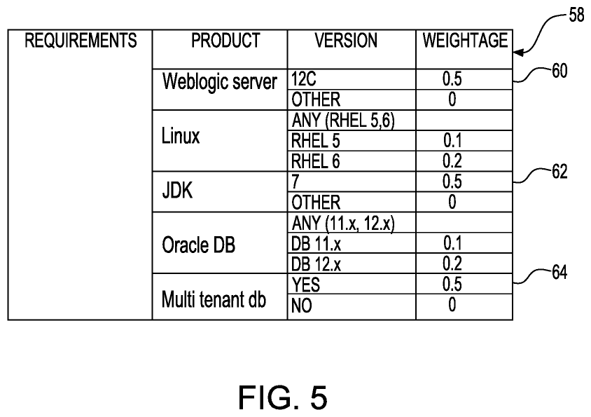

An example may be given of how the process works. Referring to FIG. 5, there is a table 58 of a user's requirements for a system. The requirements are listed by product and product version. In practice, this table may be more detailed. The user may prioritize the product requirements by assigning weightage to each of the product requirements with the higher the weightage the more important the requirement. For the purpose of illustration and not limitation, the user has chosen a scale of 0 to 1.

While the weightage values are qualitative, by following the process the user can end up with a weightage product that is quantitative and helps the choosing of a product set relative to another, similar product set.

In the listing shown in table 58, the requirements for Weblogic server 12c 60, JDk 7 62 and Multi tenant db 64 all have relatively higher weightages and are considered to be strict requirements for the system under consideration.

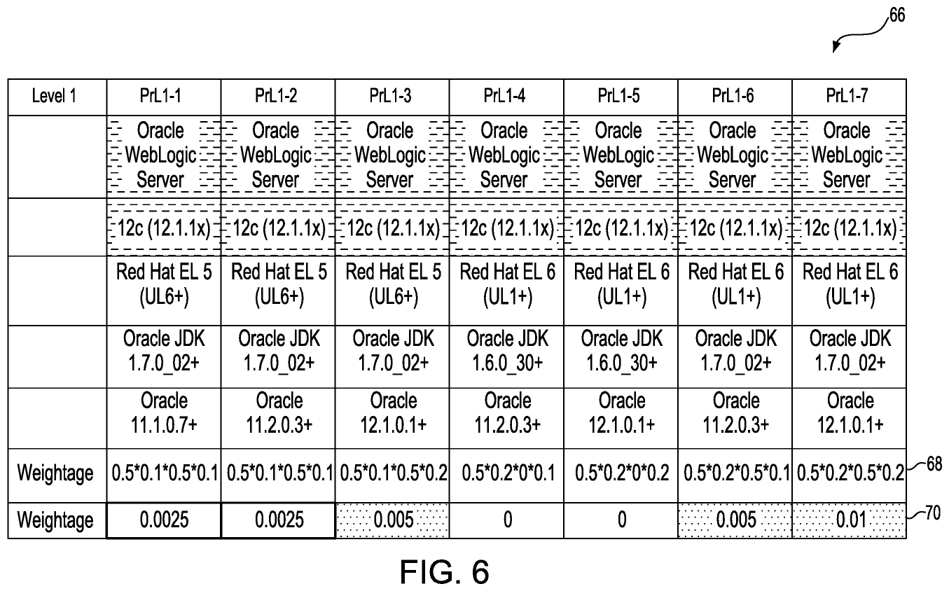

Referring now to FIG. 6, there is a table 66 listing level 1 product combinations by version with the Weblogic server being the primary product and the other products being subsidiary products. It should be understood that table 66 is only illustrative and is not meant to be representative of all product combinations. In the penultimate row 68, there is the weightage combination for all of the products listed in each row. The weightages used are those from table 58. For example, the first product combination in column PrL1-1 lists Weblogic server 12c (weightage 0.5), Red Hat EL-5 (weightage 0.1), JDK 7 (weightage 0.5) and Oracle DB 11.x (weightage 0.1). In the exemplary embodiments, the weightages are multiplied so the weightage product of PrL1-1 in the last row 70 is 0.0025. All of the other columns are done similarly. It is noted that the product combinations for PrL1-4 and PrL1-5 have a weightage product of zero, indicating an unacceptable combination.

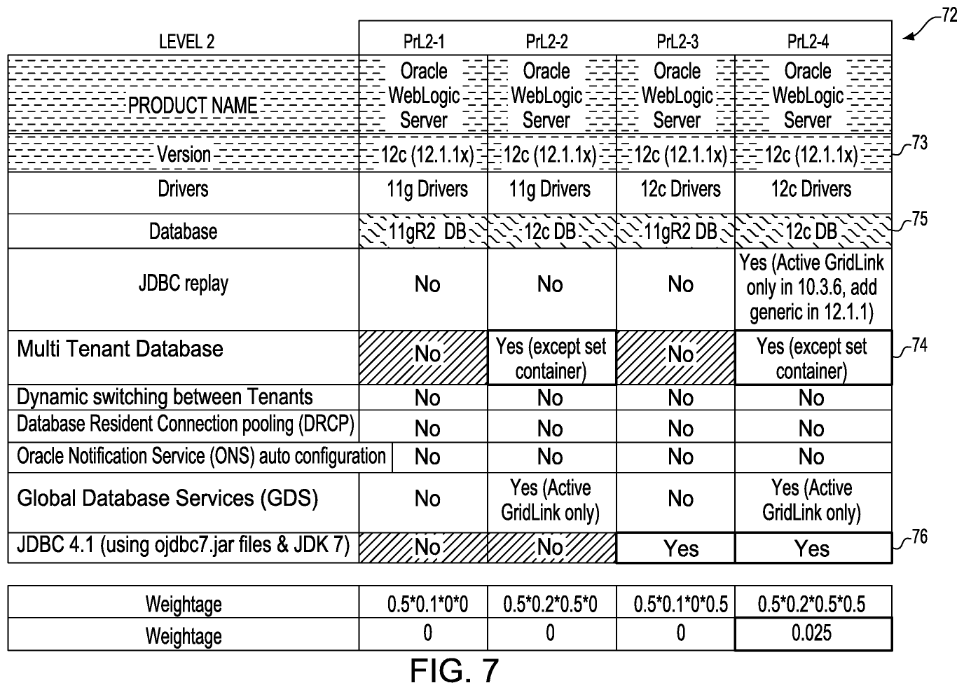

FIG. 7 illustrates table 72 which lists various level 2 technology parameter combinations for the Weblogic server. The user requires the features of Weblogic version 12c in the row labeled 73, Oracle database 11.x or 12.x in the row labeled 75, multi-tenant database in the row labled 74 and JDBC 4.1 (using JDK 7) in the row labeled 76. Multiplying the weightages from table 58 in FIG. 5 as before results in the column 4 PrL2-4 being the best parameter combination of the level 2 features. Reading the weightages for PrL2-4, the weightages from the table 58 in FIG. 5 to be used in the table 72 for FIG. 7 are 0.5 (for Weblogic server 12c), 0.2 (for Oracle DB 12.x), 0.5 (for JDK 7) and 0.5 (for multi-tenant DB).

All of the product information listed in table 66 in FIG. 6 and table 72 in FIG. 7 is readily available from vendors. The weightages are not available from vendors.

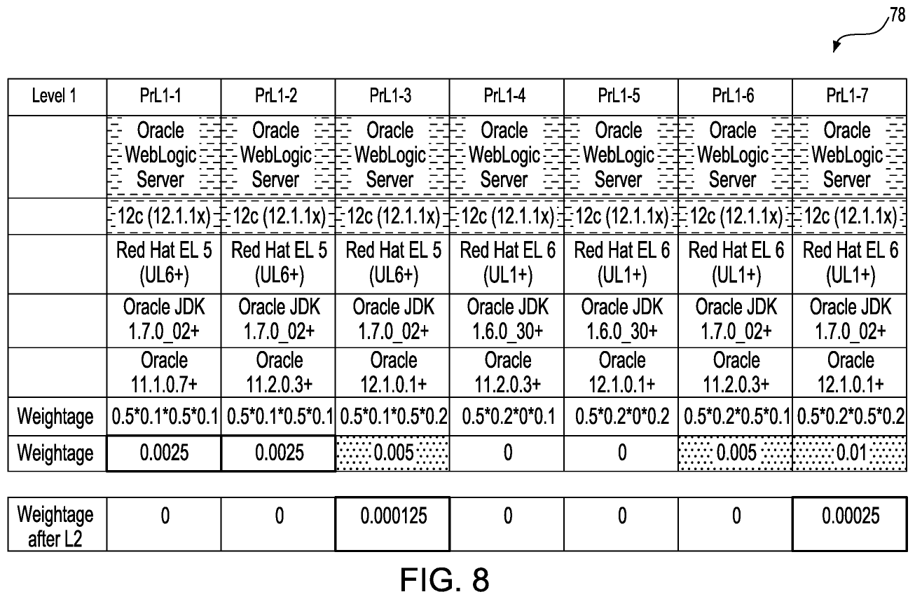

In FIG. 8, the product weightages from the FIG. 6 and FIG. 7 tables are combined to result in table 78. Comparing table 66 in FIG. 6 and table 72 in FIG. 7, the best match for product versions and features is the combination of PrL1-7 and PrL2-4. The weightage product for PrL1-7 of 0.01 is multiplied by the weightage product for PrL2-4 of 0.025 to result in a final weightage combination of 0.00025 which is the best of all the other combinations of products, versions and features.

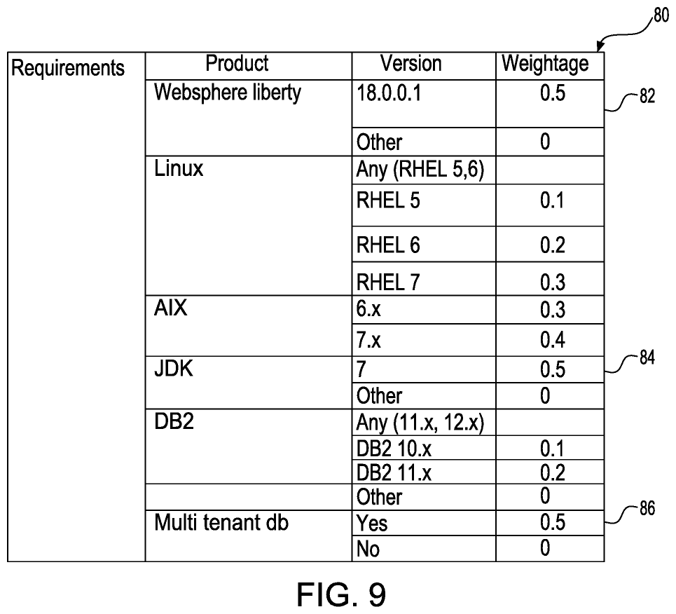

FIG. 9 illustrates another example of a user's requirements for a system. In this case, the product for comparison is Websphere liberty where previously the product was Weblogic server. Table 80 illustrates products, versions and weightages to be applied. In this example, the Websphere liberty version 18.0.0.1 having a weightage of 0.5 in row 82, JDK version 7 having a weightage of 0.5 in row 84 and multi-tenant database having a weightage of 0.5 in row 86 are strict requirements that a user must have.

As described previously with respect to FIGS. 6 to 8, tables may be formed of parameters in level 1, and possible other levels such as level 2 to arrive at an acceptable, and preferably best, match with a system meeting the user's requirements.

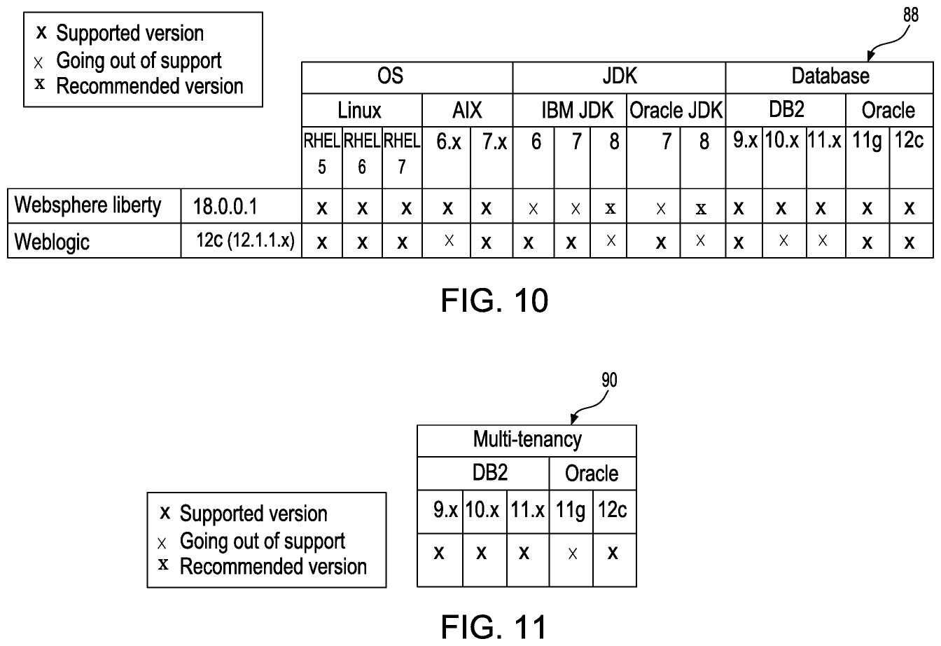

The end result of the processes in FIGS. 5 to 9 may be summarized in a technology matrix table such as table 88 in FIG. 10 where the Websphere liberty and Weblogic server products may be compared. Table 90 in FIG. 11 may also be read with table 88. Table 90 is a depiction of the capability of the databases as to which version supports multi-tenancy. The parameters compared in tables 88 and 90 are operating system, JDK, Database and Multi-tenancy. With the use of these tables, a recommendation may be made to a user for the best match of a system to fit the user's needs.

Having created the table such as that in FIG. 10, a recommendation may be made to a user. However, it may be useful to seek out information from the other users of the technology to “fine tune” the recommendation to the user or seek alternatives for the user. The information from the other uses of the technology is optional and need not be used but it is preferable to use it.

The weightage assigned in the following tables is qualitative and is based on the best information available at the time the transformation is considered. As more transformations will occur, the data may become quantitative due to the greater number of datapoints. For example, with respect to vendor information, there may be few technotes (say ten technotes) in an early technology cycle so that when considering a transformation, the developer may use his best judgement as to what the weightage should be. However, after some time and experience with the technology, there may be a thousand technotes so that it becomes easier to arrive at a quantitative weightage based on the number of users who may have indicated a favorable compatibility of the product.

Weightage Based on Published Vendor Information where X=0 to 1:

| Technotes | Vendor articles | Testcase reference | User experience |
|---|---|---|---|
| X1 | X2 | X3 | X4 |

Weightage Based on Social Forums where Y=0 to 1:

| Blog | Twitter dwAmswers | dwAmswers | StackOverFlow |
|---|---|---|---|
| Y1 | Y2 | Y3 | Y4 |

Weightage Based on Content Usage/References/Feedback where W=0 to 1:

| | | How many times | How many times |
|---|---|---|---|
| | | information was | information was |
| Relevancy | User feedback | referenced | actually used |
| W1 | W2 | W3 | W4 |

For each combination, an actual score may be determined for ranking and presenting the options to the end user. An example follows below:

| | | | | Actual | Maximum | Rank score = |
|---|---|---|---|---|---|---|
| Product(s) | X | Y | W | score = | possible | actual/ |
| combination | score | score | score | X + Y + W | score (3) | maximum |
| A | 0.5 | 0.6 | 1 | 2.1 | 3 | 0.7 |
| B | 0.8 | 0.4 | 0.5 | 1.7 | 3 | 0.56 |
| C | 1 | 0.8 | 0.7 | 2.5 | 3 | 0.83 |

Based on the higher ranking, the Product Combination C may be recommended to the end user.

FIG. 2 refers to self-learning. Learning is proposed to be done at multiple levels:
Extend, deprecate relationship models—Algorithm based intelligence that will actively seek to replenish relationships based on structured and unstructured data.
Analyze inputs and user interactions to enhance the system.
Intelligent authorization requests for approval of conflicting or ambiguous relationships.
In case of a conflict the authorization should a) ask for an intervention for manual decision making and/or b) ask for more criteria for refinement.

New information, feedback, comments from end users and subject matter experts are passed back to the central repository. New relationships/rules are established and weightage adjusted while keeping the relevancy of information/grouping. The newly integrated information will be presented during information retrieval. Learning takes place when new information is added to the existing knowledge base.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent to those skilled in the art having regard to this disclosure that other modifications of the exemplary embodiments beyond those embodiments specifically described here may be made without departing from the spirit of the invention. Accordingly, such modifications are considered within the scope of the invention as limited solely by the appended claims.

What is claimed is:

1. A computer-implemented method of integrating a computing system comprising:
identifying component products for the computing system;
identifying possible versions of each of the component products;
prioritizing the possible versions for each of the component products so as to emphasize those versions that are most important to a user of the computing system;
selecting one product as a primary product of the computing system with the remaining products being subsidiary products;
forming a technology matrix of possible combinations of primary product, subsidiary products and possible versions of the subsidiary products; and
selecting the combination of primary product, subsidiary product and subsidiary product version having the highest prioritization;
wherein the method is implemented by a processor.

2. The method of claim 1 wherein prioritizing the possible versions comprises assigning a relative weightage to each version of each product with the highest relative weightage corresponds to a product/product version that is of highest importance to a user.

3. The method of claim 2 wherein selecting the combination of primary product, subsidiary product and subsidiary product version having the highest prioritization comprises multiplying the relative weightage for each primary product/primary product version and each subsidiary product/subsidiary product version of the combination of primary product, subsidiary product and subsidiary product version.

4. The method of claim 1 wherein the technology matrix is in the form of a table with each column of the table headed by the primary product and comprising entries in the each column of a subsidiary product and subsidiary product version.

5. The method of claim 1 wherein the technology matrix is a comparison of the component products at a first level of a hierarchy and further comprising forming a second technology matrix comprising technology parameters for the primary product and primary product version wherein the second technology matrix is at a second level of the hierarchy.

6. The method of claim 5 wherein the second technology matrix is a technology table with each column of the table headed by the primary product and comprising entries in the each column of technology parameters applicable to the primary product.

7. A computer program product for integrating a computing system, the computer program product comprising:
a computer readable storage medium having computer readable program code embodied therewith, the computer readable program code comprising:
computer readable program code configured to identify component products for the computing system;
computer readable program code configured to identify possible versions of each of the component products;
computer readable program code configured to prioritize the possible versions for each of the component products so as to emphasize those versions that are most important to a user of the computing system;
computer readable program code configured to select one product as a primary product of the computing system with the remaining products being subsidiary products;
computer readable program code configured to form a technology matrix of possible combinations of primary product, subsidiary products and possible versions of the subsidiary products; and
computer readable program code configured to select the combination of primary product, subsidiary product and subsidiary product version having the highest prioritization.

8. The computer program product of claim 7 wherein prioritize the possible versions comprises assign a relative weightage to each version of each product with the highest relative weightage that corresponds to a product/product version that is of highest importance to a user.

9. The computer program product of claim 8 wherein select the combination of primary product, subsidiary product and subsidiary product version having the highest prioritization comprises multiplying the relative weightage for each primary product/primary product version and each subsidiary product/subsidiary product version of the combination of primary product, subsidiary product and subsidiary product version.

10. The computer program product of claim 7 wherein the technology matrix is in the form of a table with each column of the table headed by the primary product and comprising entries in the each column of a subsidiary product and subsidiary product version.

11. The computer program product of claim 7 wherein the technology matrix is a comparison of the component products at a first level of a hierarchy and further comprising forming a second technology matrix comprising technology parameters for the primary product and primary product version wherein the second technology matrix is at a second level of the hierarchy.

12. The computer program product of claim 11 wherein the second technology matrix is a technology table with each column of the table headed by the primary product and comprising entries in the each column of technology parameters applicable to the primary product.

13. A system for integrating a computing system comprising:
a processor that executes the instructions to perform the following functions:
identify component products for the system;
identify possible versions of each of the component products;
prioritize the possible versions for each of the component products so as to emphasize those versions that are most important to a user of the system;
select one product as a primary product of the system with the remaining products being subsidiary products;
form a technology matrix of possible combinations of primary product, subsidiary products and possible versions of the subsidiary products; and
select the combination of primary product, subsidiary product and subsidiary product version having the highest prioritization.

14. The method of claim 13 wherein prioritizing the possible versions comprises assigning a relative weightage to each version of each product with the highest relative weightage corresponds to a product/product version that is of highest importance to a user.

15. The method of claim 14 wherein selecting the combination of primary product, subsidiary product and subsidiary product version having the highest prioritization comprises multiplying the relative weightage for each primary product/primary product version and each subsidiary product/subsidiary product version of the combination of primary product, subsidiary product and subsidiary product version.

16. The method of claim 13 wherein the technology matrix is in the form of a table with each column of the table headed by the primary product and comprising entries in the each column of a subsidiary product and subsidiary product version.

17. The method of claim 13 wherein the technology matrix is a comparison of the component products at a first level of a hierarchy and further comprising forming a second technology matrix comprising technology parameters for the primary product and primary product version wherein the second technology matrix is at a second level of the hierarchy.

18. The method of claim 17 wherein the second technology matrix is a technology table with each column of the table headed by the primary product and comprising entries in the each column of technology parameters applicable to the primary product.
